(19) United States
(12) Patent Application Publication
(10) Pub. No.: US 2026/0116721 A1
(43) Pub. Date: Apr. 30, 2026

(54) Systems and Methods for Docking Automated Guided Vehicles to a Material Handling Vehicle

(71) Applicant: The Raymond Corporation, Greene, NY (US)

(72) Inventors: Fernando D. Goncalves, Vestal, NY (US); Joshua T. Smith, Chenango Forks, NY (US); Joseph A. Weiss, Greene, NY (US); Craig Fahrenkrug, Vestal, NY (US); Alan W. Bartels, Wilton, IA (US)

(21) Appl. No.: 19/057,669

(22) Filed: Feb. 19, 2025

Related U.S. Application Data
(60) Provisional application No. 63/555,297, filed on Feb. 19, 2024.

(51) Int. Cl. B66F 9/18; B66F 9/06

(52) U.S. Cl. CPC B66F 9/18; B66F 9/063

(57) ABSTRACT

A material handling vehicle may include a vertically moveable platform including an operator compartment and a load deck and a connection mechanism to secure an automated guided vehicle to the load deck. In some examples, the connection mechanism secures the automated guided vehicle to the load deck so that vertical movement of the load deck elicits corresponding vertical movement of the automated guided vehicle.

### CROSS-REFERENCE TO RELATED APPLICATIONS

This application claims the benefit of U.S. Provisional Application No. 63/555,297, filed Feb. 19, 2024, which is hereby incorporated by reference in its entirety.

### BACKGROUND

Automated guided vehicles (AGVs) may be used in warehouse environments to assist operators in order picking operations. For example, AGVs may provide route guidance, optimization, or other efficiency-increasing benefits to an operator. However, AGVs are typically limited to only low-level order picking. Thus, higher-level order picking operations are unable to make use of the efficiency-increasing benefits of AGVs.

### SUMMARY

In one aspect, the present disclosure describes a material handling vehicle. The material handling vehicle includes a vertically moveable platform including an operator compartment and a load deck and a connection mechanism to secure an automated guided vehicle to the load deck. The connection mechanism secures the automated guided vehicle to the load deck so that vertical movement of the load deck elicits corresponding vertical movement of the automated guided vehicle.

In another aspect, the present disclosure describes a method of docking an automated guided vehicle to a material handling vehicle. The method includes identifying a material handling vehicle via an automated guided vehicle, beginning to dock the automated guided vehicle to the material handling vehicle by guiding the automated guided vehicle onto a load deck of the material handling vehicle, and securing the automated guided vehicle to the load deck of the material handling vehicle via a connection mechanism secured to the load deck.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a diagrammatic view of a material handling vehicle according to aspects of the present disclosure.

FIG. 2 is a perspective view of a portion of the material handling vehicle of FIG. 1 including a load deck according to aspects of the present disclosure.

FIG. 3 is a top view of the material handling vehicle including the load deck of FIG. 2 according to aspects of the present disclosure.

FIG. 4 is a bottom perspective view of the material handling vehicle including the load deck of FIG. 2 according to aspects of the present disclosure.

FIG. 5 is a side view of another example of the material handling vehicle of FIG. 1 including another example of a load deck according to aspects of the present disclosure.

FIG. 6 is a side view of the material handling vehicle including the load deck of FIG. 5 according to aspects of the present disclosure.

FIG. 7 is a top view of the material handling vehicle including the load deck of FIG. 6 according to aspects of the present disclosure.

FIG. 8 is a perspective view of an automated guided vehicle for use with the material handling vehicle of FIG. 1 according to aspects of the present disclosure.

FIG. 9 is a front view of the automated guided vehicle of FIG. 8 according to aspects of the present disclosure.

FIG. 10 is a bottom view of the automated guided vehicle of FIG. 8 secured to the material handling vehicle of FIG. 1 via a connection mechanism according to aspects of the present disclosure.

FIG. 11 is a cross-sectional partial view of the connection mechanism of FIG. 10 according to aspects of the present disclosure.

FIG. 12 is a bottom view of another example of a connection mechanism for securing the automated guided vehicle of FIG. 8 to the material handling vehicle of FIG. 1 according to aspects of the present disclosure.

FIG. 13 is a partial side view of yet another example of a connection mechanism for securing the automated guided vehicle of FIG. 8 to the material handling vehicle of FIG. 1 according to aspects of the present disclosure.

FIG. 14 is a front view of a platform of the material handling vehicle of FIG. 1 according to aspects of the present disclosure.

FIG. 15 is a diagrammatic view of sensor integration between the automated guided vehicle of FIG. 8 and the material handling vehicle of FIG. 1 according to aspects of the present disclosure.

FIG. 16 is a flowchart of an order picking process utilizing the automated guided vehicle of FIG. 8 and the material handling vehicle of FIG. 1 according to aspects of the present disclosure.

FIG. 17 is a flowchart of a docking process for docking the automated guided vehicle of FIG. 8 to the material handling vehicle of FIG. 1 according to aspects of the present disclosure.

FIG. 18 is a flowchart of an undocking process for undocking the automated guided vehicle of FIG. 8 to the material handling vehicle of FIG. 1 according to aspects of the present disclosure.

FIG. 19 is a flowchart of another example of a docking process for docking the automated guided vehicle of FIG. 8 to the material handling vehicle of FIG. 1 according to aspects of the present disclosure.

FIG. 20 is a diagrammatic view of the material handling vehicle of FIG. 1 executing a pick-up/drop-off process with the automated guided vehicle of FIG. 8.

### DETAILED DESCRIPTION

The following discussion is presented to enable a person skilled in the art to make and use embodiments of the invention. Given the benefit of this disclosure, various modifications to the illustrated embodiments will be readily apparent to those skilled in the art, and the principles herein can be applied to other embodiments and applications without departing from embodiments of the invention. Thus, embodiments of the invention are not intended to be limited to embodiments shown but are to be accorded the widest scope consistent with the principles and features disclosed herein.

The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

It is also to be appreciated that material handling vehicles are designed in a variety of classes and configurations to perform a variety of tasks. It will be apparent to those of skill in the art that the present disclosure is not limited to any specific material handling vehicle, and can also be provided with various other types of material handling vehicle classes and configurations, including for example, lift trucks, forklift trucks, reach trucks, SWING REACH® vehicles, turret trucks, side loader trucks, counterbalanced lift trucks, pallet stacker trucks, order pickers, transtackers, tow tractors, and man-up trucks, and can be commonly found in warehouses, factories, shipping yards, and, generally, wherever pallets, large packages, or loads of goods can be required to be transported from place to place. The various systems and methods disclosed herein are suitable for any of operator controlled, pedestrian controlled, remotely controlled, and autonomously controlled material handling vehicles. Further, the present disclosure is not limited to material handling vehicles applications. Rather, the present disclosure may be provided for other types of vehicles, such as automobiles, buses, trains, tractor-trailers, farm vehicles, factory vehicles, and the like.

It should be noted that the various material handling vehicles listed above may perform a variety of load handling functions. For example, the material handling vehicles and/or the load handling portion (e.g., forks, mast, and/or fork carriage, etc.) of the material handling vehicles may be operated to traverse (e.g., move the forks up to a full load depth), tilt, reach (e.g., move the forks up to a partial load depth), rotate, drive (e.g., move the material handling vehicles), travel (e.g., move the material handling vehicles), and/or any combination thereof to complete a load handling function.

As should be noted, for certain types of vehicles there are training requirements imposed by various government agencies, laws, rules and regulations. For example, OSHA imposes a duty on employers to train and supervise operators of various types of material handling vehicles. Recertification every three years is also required. In certain instances, refresher training in relevant topics shall be provided to the operator when required. In all instances, the operator remains in control of the material handling vehicle during performance of any actions. Further, a warehouse manager remains in control of the fleet of material handling vehicles within the warehouse environment. The training of operators and supervision to be provided by warehouse managers requires among other things proper operational practices including among other things that an operator remain in control of the material handling vehicle, pay attention to the operating environment, and always look in the direction of travel.

In some examples, a material handling vehicle may include a vertically moveable platform including a load deck configured to receive and retain an automated guided vehicle. In some examples, the load deck may secure the automated guided vehicle to the material handling vehicle. For example, the load deck may include a series of slots configured to receive and retain one or more wheels of the automated guided vehicle. In another example, the load deck may be segmented with a second segment configured to move from a position parallel to a first segment to a position perpendicular to the first segment to retain the automated guided vehicle. In other examples, the automated guided vehicle may be secured to the platform via one or more forks extending from the platform. For example, the one or more forks of the material handling vehicle may include a connection mechanism configured to receive and retain a portion of the automated guided vehicle to secure the automated guided vehicle to the material handling vehicle. As a result, the automated guided vehicle may be raised or lowered along with the platform (e.g., to permit the automated guided vehicle to reach above floor-level items). In another example, the automated guided vehicle may be raised or lowered along with the platform to permit the automated guided vehicle to be delivered to another floor or level of a warehouse or other facility. For example, the automated guided vehicle may dock to the material handling vehicle and then the material handling vehicle may raise the automated guided vehicle to the desired floor (e.g., mezzanine, second story, etc.) where the automated guided vehicle may then undock and resume a pick process.

In another example, the automated guided vehicle may engage with a communication port (wired or wirelessly) of the platform when docked to the material handling vehicle. For example, the communication port may permit the automated guided vehicle to utilize one or more sensors or cameras of the material handling vehicle to autonomously guide the material handling vehicle via a guidance system of the automated guided vehicle. Put differently, via the communications port, the automated guided vehicle may autonomously guide the material handling vehicle according to a route planning system of the automated guided vehicle. Thus, the material handling vehicle may benefit from the efficient route planning of the automated guided vehicle, while the automated guided vehicle may benefit from the above floor-level reach of the material handling vehicle.

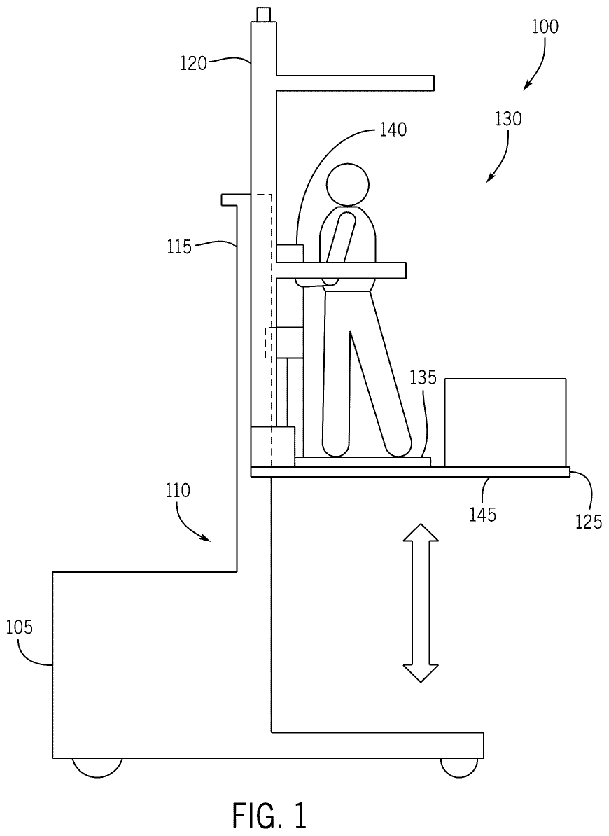

FIG. 1 illustrates an example of a material handling vehicle 100. The material handling vehicle 100 includes a tractor unit 105, and a vertically extendable mast 110 mounted relative to the tractor unit 105. The mast 110 includes a fixed mast section 115 and an extendable mast section 120, with a vertically movable platform 125 attached to the extendable mast section 120. In some examples, the extendable mast section 120 raises and lowers the platform 125.

In some examples of the material handling vehicle 100, the platform 125 includes an operator compartment 130, which may also be called an operator station. The operator compartment 130 includes an operator platform 135 on which the operator sits or stands, and an operator console 140 for operation of the material handling vehicle 100, including operation of the platform functions. The console 140 includes controls for controlling vehicle steering and speed, and includes controls for controlling raising and lowering the platform 125, and operation of one or more forks 145, which may be called platform forks. The operator compartment 130 may also include lights, and one or more displays for displaying operational data. In other examples, the material handling vehicle 100 may include a fixed operator compartment on the tractor unit 105 (i.e., where the operator does not travel up and down with the platform), or may not include a designated operator compartment, such as when the operator does not stand on the material handling vehicle 100, but walks alongside the material handling vehicle 100 and controls the vehicle using a control handle.

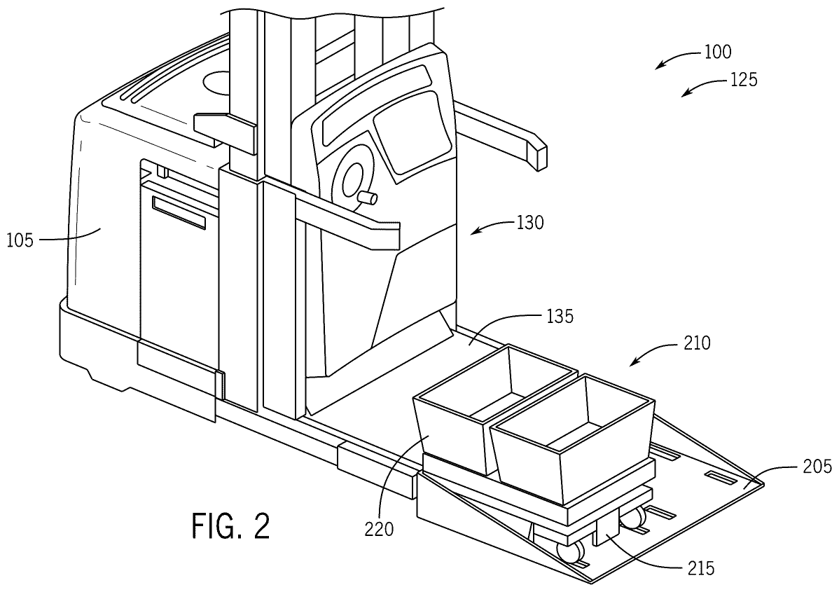

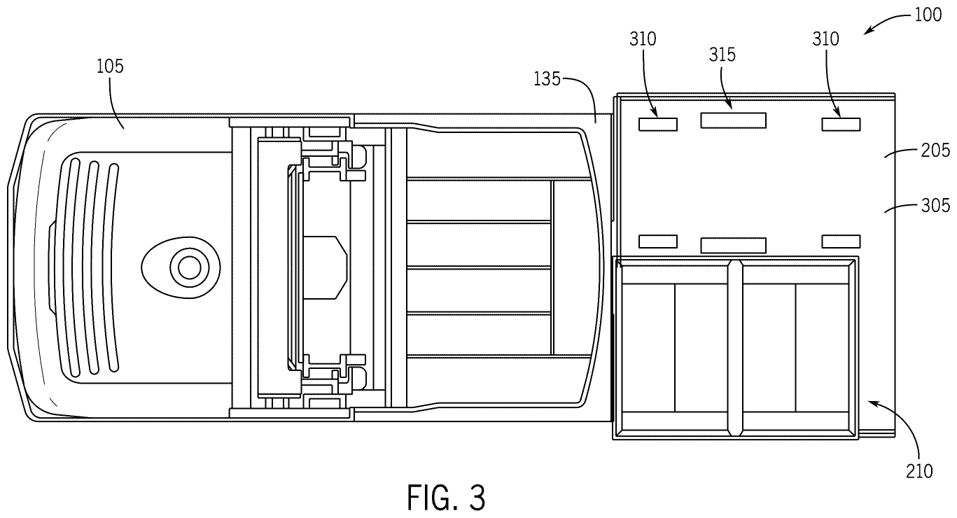

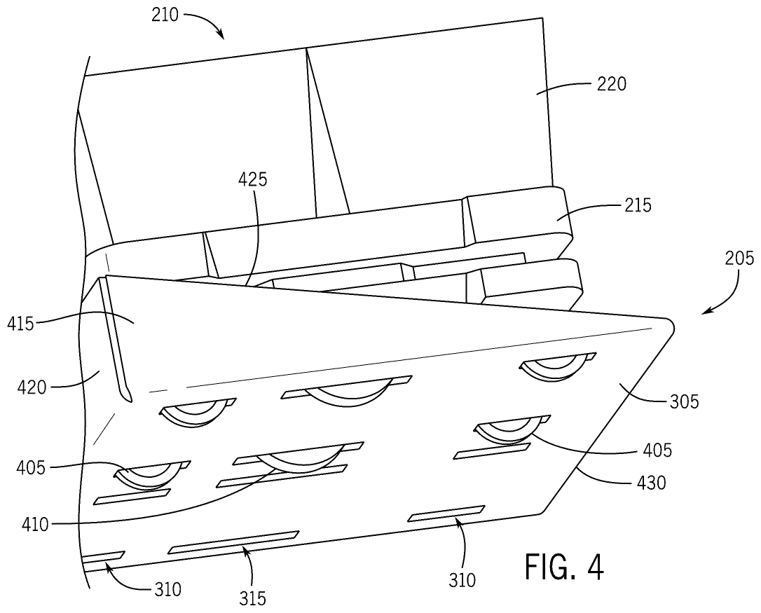

FIGS. 2-4 show some examples of the material handling vehicle 100 including a platform 125 having a load deck 205 to retain and secure an automated guided vehicle 210. As mentioned previously, the automated guided vehicle 210 may be raised or lowered along with the platform 125 (including load deck 205) to permit the automated guided vehicle 210 to reach above floor-level items. In another example, the automated guided vehicle 210 may be raised or lowered along with the platform 125 to permit the automated guided vehicle 210 to be delivered to another floor or level of a warehouse or other facility. For example, the automated guided vehicle 210 may dock to the material handling vehicle 100 (e.g., via the load deck 205) and then the material handling vehicle 100 may raise the automated guided vehicle 210 to the desired floor (e.g., mezzanine, second story, etc.) where the automated guided vehicle 210 may then undock and resume a pick process.

In some examples, the automated guided vehicle 210 may include a chassis 215 and one or more storage receptacles 220. For example, the chassis 215 may include a powertrain, guidance, navigation, and control system, one or more cameras, and one or more sensors to control operation of the automated guided vehicle 210. Correspondingly, the storage receptacles 220 may be in the form of baskets, shelves, or any other known storage systems. In some examples, an operator may place picked items within the storage receptacles 220 during a picking operation. For example, the operator may be present on the operator platform 135 and operating the material handling vehicle 100 via the console 140 according to instructions from a warehouse management system or the automated guided vehicle 210. Thus, the operator may benefit from route planning of the automated guided vehicle 210, which may increase overall order picking efficiency and reduce overall downtime.

In some examples, to secure the automated guided vehicle 210 to the material handling vehicle 100, the automated guided vehicle 210 may traverse onto the load deck 205 so that one or more wheels 405, 410 of the chassis 215 slide into or engage one or more slots 310, 315 defined by a floor 305 of the load deck 205. Thus, when the platform 125 raises, the automated guided vehicle 210 is secured to the platform 125 (e.g., the load deck 205) via engagement between the wheels 405, 410 and the slots 310, 315. However, when the platform 125 lowers, the wheels 405, 410 contact the floor of the warehouse prior to the load deck 205, which applies a force to the automated guided vehicle 210 to dislodge the wheels 405, 410 from the slots 310, 315.

In some examples, the load deck 205 may include a pair of opposing sidewalls 415 extending upward from the floor 305 of the load deck 205. In some examples, the sidewalls 415 may include an angled upper surface 425 extending from a first end 430 of the load deck 205 to an end wall 420 of the load deck 205. As should be appreciated, in other examples, the sidewalls 415 may define other shapes, such as rectangular, polygonal, or other shapes. The end wall 420 of the load deck 205 may separate the load deck 205 from the operator platform 135 of the platform 125. In some examples, the end wall 420 may include one or more mechanical or electrical connectors to integrate the automated guided vehicle 210 into the material handling vehicle 100 (e.g., for integration between a control system of the material handling vehicle 100 and a control system of the automated guided vehicle 210).

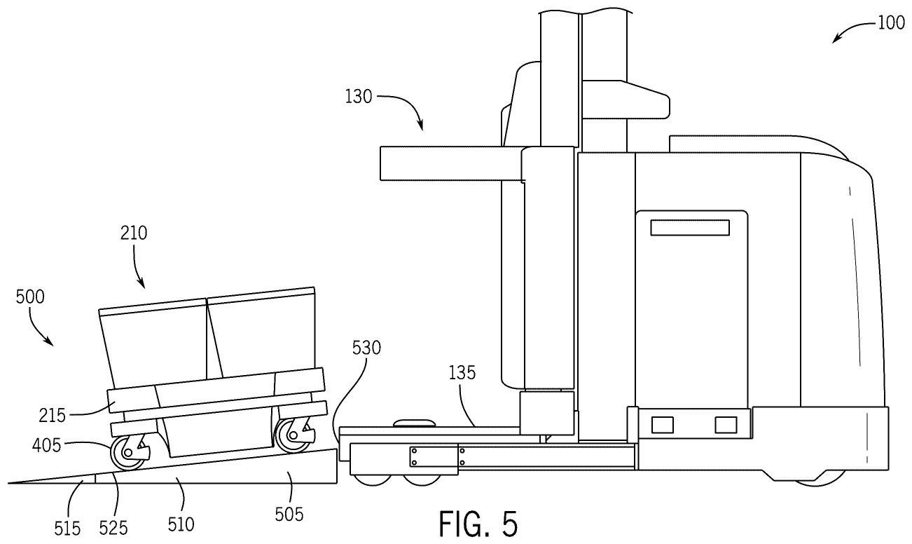

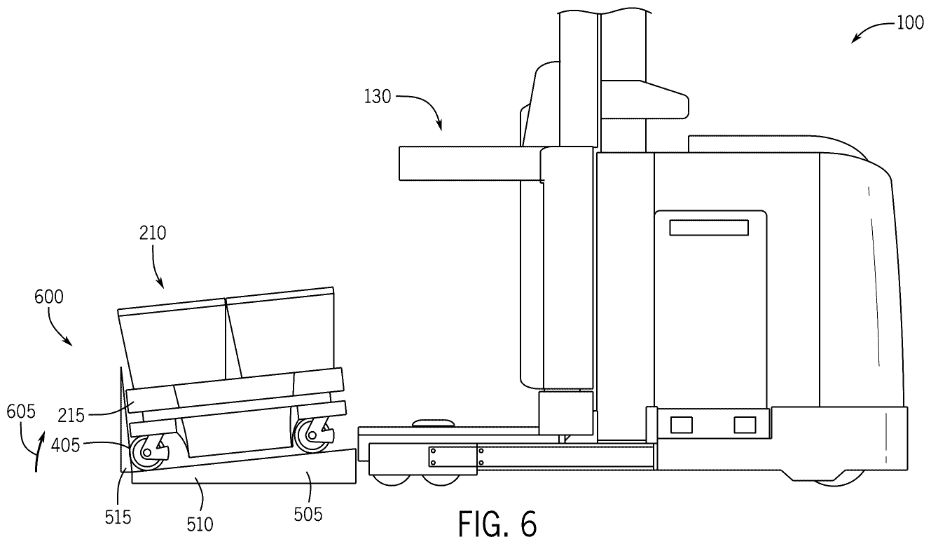

FIGS. 5 and 6 show another example of the material handling vehicle 100 including a load deck 505. In some examples, the load deck 505 may define a segmented body having a first segment 510 and a second segment 515. In some examples, the second segment 515 may be configured to rotate as shown by arrow 605 to form a backstop of the load deck 505. As should be appreciated, the second segment 515 may move from a first position 500 (e.g., shown in FIG. 5) to a second position 600 (e.g., shown in FIG. 6) to retain the automated guided vehicle 210 on the load deck 505.

In an example use case, the automated guided vehicle 210 may drive onto the load deck 505, which may include an angled surface 525 to facilitate guidance of the automated guided vehicle 210 onto the load deck 505. In some examples, the automated guided vehicle 210 continues to advance on the load deck 505 until the automated guided vehicle 210 reaches an end wall 530 of the load deck 505. Once the automated guided vehicle 210 reaches the end wall 530, the second segment 515 may rotate into the second position 600 to secure the automated guided vehicle 210 to the load deck 505. In some examples, the second segment 515 may move from the first position 500 to the second position 600 automatically once the automated guided vehicle 210 engages (e.g., contacts) the end wall 530. In another example, the second segment 515 may move from the first position 500 to the second position 600 upon actuation of a switch or button by an operator, for example.

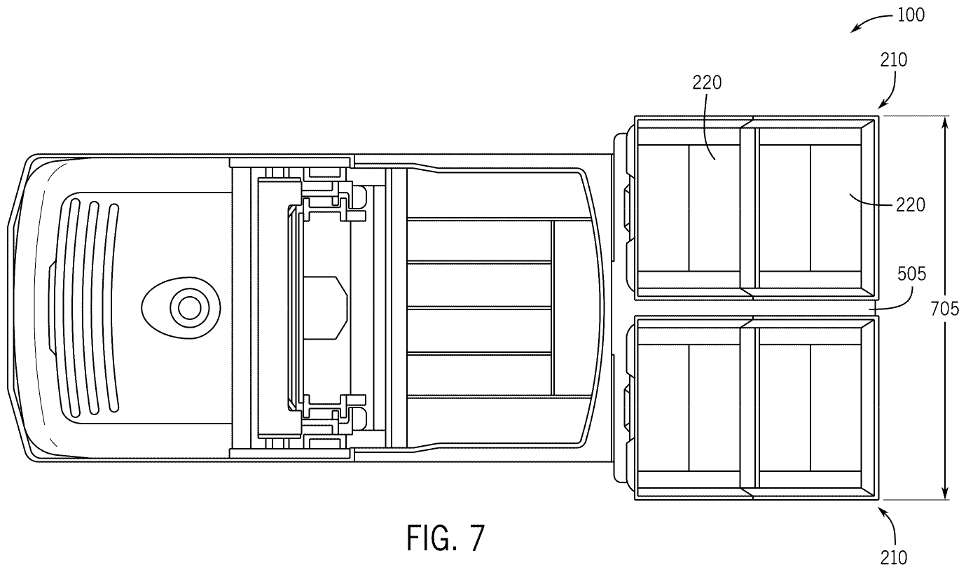

As shown in FIG. 7, the load deck 505 includes a width 705, which may correspond to a width of the operator platform 135. In some examples, the width 705 may be sized to permit a pair of automated guided vehicles 210 to fit on the load deck 505. In other examples, the width 705 of the load deck 505 may be sized to retain only a single automated guided vehicle 210 or more than a pair of the automated guided vehicles 210.

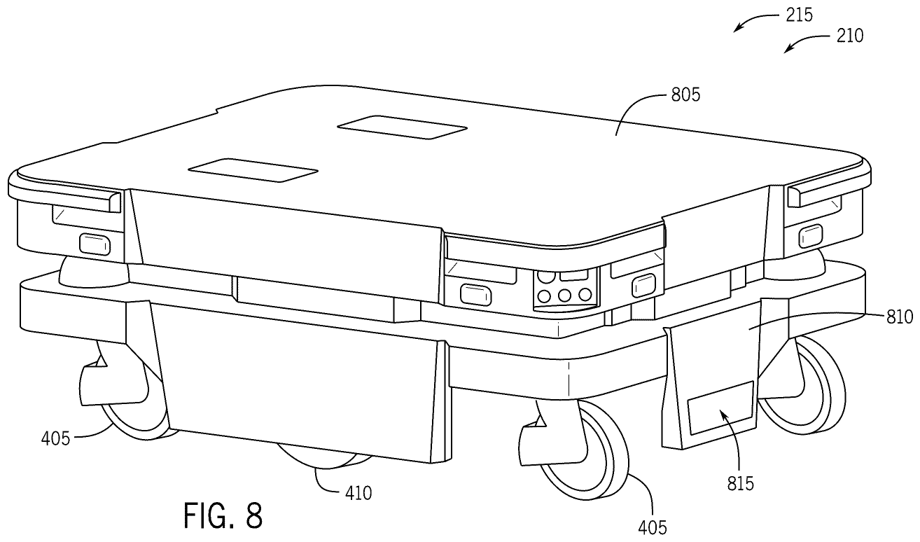

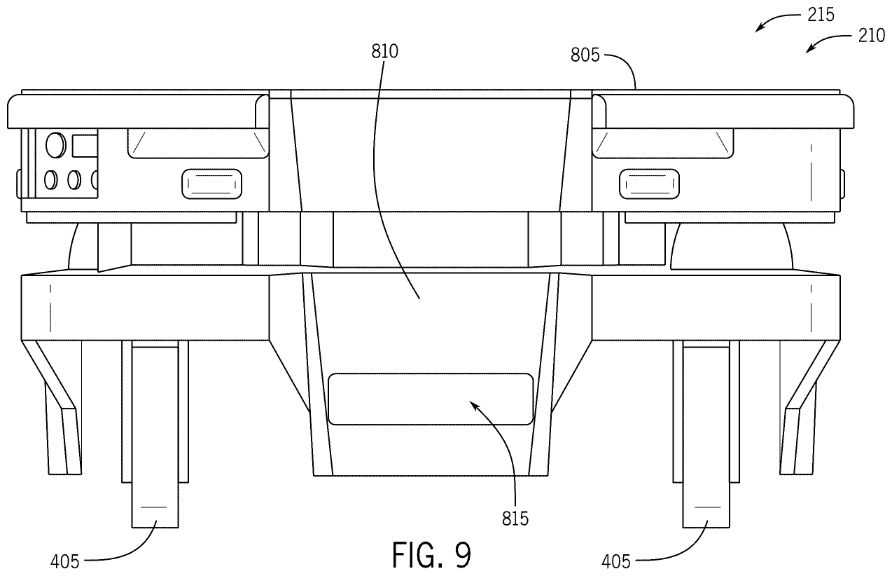

FIGS. 8 and 9 illustrate an example of the chassis 215 of the automated guided vehicle 210. The chassis 215 may include a load surface 805, which may receive and retain the one or more storage receptacles 220. Correspondingly, the chassis 215 may include a body, which may house internal components of the chassis 215 (e.g., one or more sensors, one or more cameras, a guidance, navigation, and control system, a powertrain system, etc.). In some examples, the chassis 215 may include a fork receptacle 810 defining an opening 815. The opening 815 is configured to receive a fork 145 of the material handling vehicle 100 to secure the automated guided vehicle 210 to the material handling vehicle 100. Further, the fork receptacle 810 may include a pair of openings 815 arranged on each end of the chassis 215. Thus, the fork receptacle 810 may assist in alignment of the automated guided vehicle 210 on the fork 145 of the material handling vehicle 100.

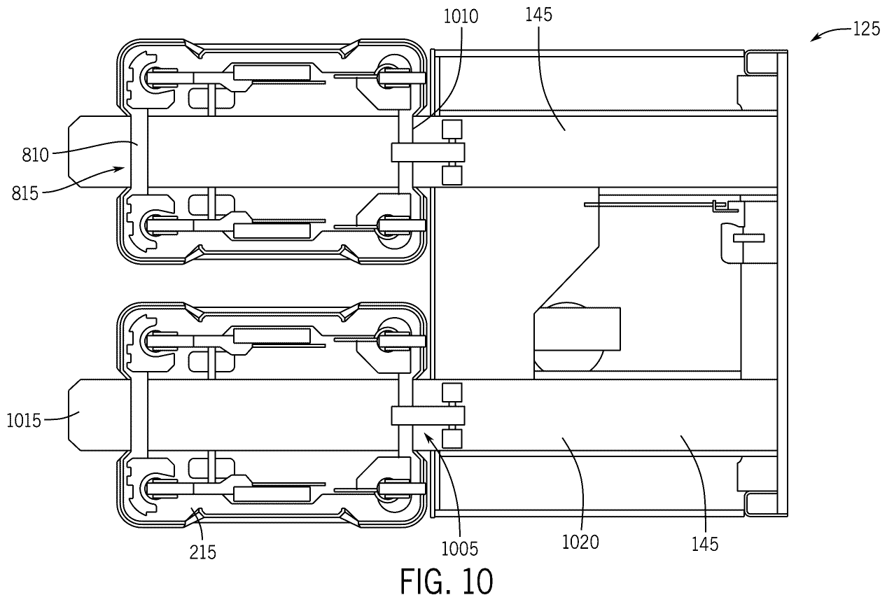

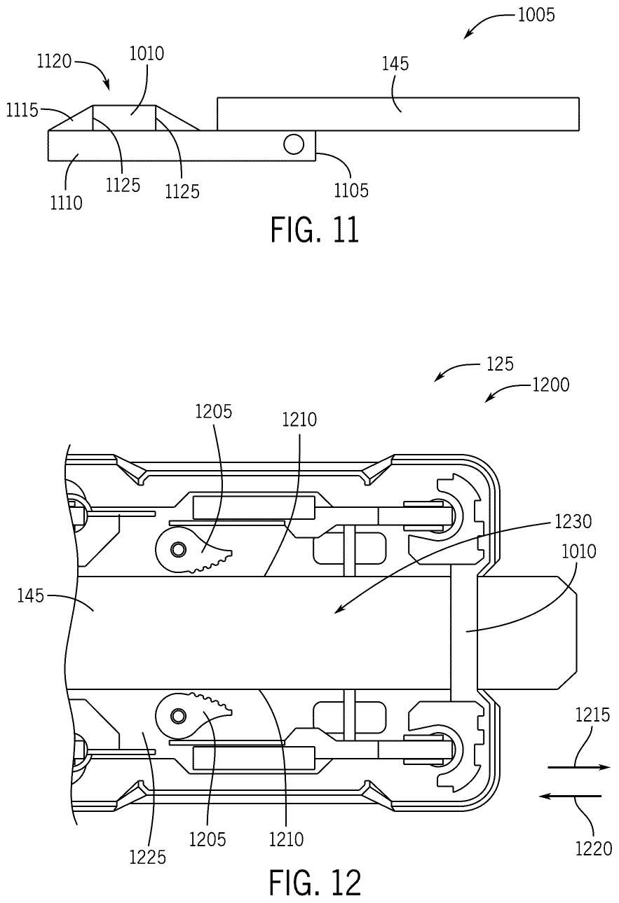

As shown in FIGS. 10 and 11, the material handling vehicle 100 may include a connection mechanism 1005 arranged on an underside 1020 of each of the forks 145. In some examples, the connection mechanism 1005 may engage and retain a crossmember 1010 of the chassis 215 to secure the automated guided vehicle 210 to the material handling vehicle 100. The connection mechanism 1005 may include a mounting shaft 1105 to secure the connection mechanism 1005 to the forks 145. In some examples, the connection mechanism 1005 may be pivotally secured to the forks 145. In some examples, the connection mechanism 1005 includes a body 1110 having an angled nose 1115. The angled nose 1115 may elicit rotational movement of the connection mechanism 1005 via engagement between the crossmember 1010 of the chassis 215 and the angled nose 1115.

In some examples, as the chassis 215 moves along the forks 145, the crossmember 1010 may contact the angled nose 1115 of the connection mechanism 1005, which may elicit rotational movement of the body 1110 via the mounting shaft 1105. In some examples, the body 1110 includes a cutout 1120 defined by one or more walls 1125. The cutout 1120 may be sized to receive and retain the crossmember 1010 to secure the automated guided vehicle 210 to the material handling vehicle 100. For example, once the crossmember 1010 reaches the cutout 1120, the crossmember 1010 may fall into the cutout 1120 of the connection mechanism 1005. Further, the connection mechanism 1005 may include a biasing element to bias the connection mechanism into a closed position (e.g., where the connection mechanism is arranged parallel to the forks 145. In some examples, to release the crossmember 1010 from the connection mechanism 1005, an operator may actuate a switch or button, which may elicit rotation of the connection mechanism 1005 and releases the crossmember 1010 from the cutout 1120.

FIG. 12 shows another example of a connection mechanism 1200 for securing the automated guided vehicle 210 to the material handling vehicle 100. In some examples, the chassis 215 of the automated guided vehicle 210 may include one or more locking pawls 1205 secured to an underside 1225 of the chassis 215. In some examples, the locking pawls 1205 may be unidirectional (e.g., permit movement in only a single direction) so that the fork 145 may be inserted through an opening 1230 defined by the locking pawls 1205 in a first direction shown by arrow 1215, but may not be removed from the opening 1230 defined by the locking pawls 1205 in a second, opposite direction shown by arrow 1220. Thus, the automated guided vehicle 210 may be secured to the material handling vehicle 100 via engagement between the locking pawls 1205 and a surface or surfaces of the forks. This surface may be a side 1210 or the sides 1210 of the forks 145. In another example, only a single locking pawl 1205 may be used to secure the automated guided vehicle 210 to the material handling vehicle 100. For example, the fork 145 may be inserted through an opening defined by a locking pawl 1205 in a first direction but may not be removed from the opening defined by the locking pawl in a second, opposite direction. In some examples, the fork 145 may be retained between (e.g., sandwiched between) a sidewall of the chassis 215 and the locking pawl 1205. Thus, the automated guided vehicle 210 may be secured to the material handling vehicle 100 via engagement between the locking pawl 1205 and a surface of the forks.

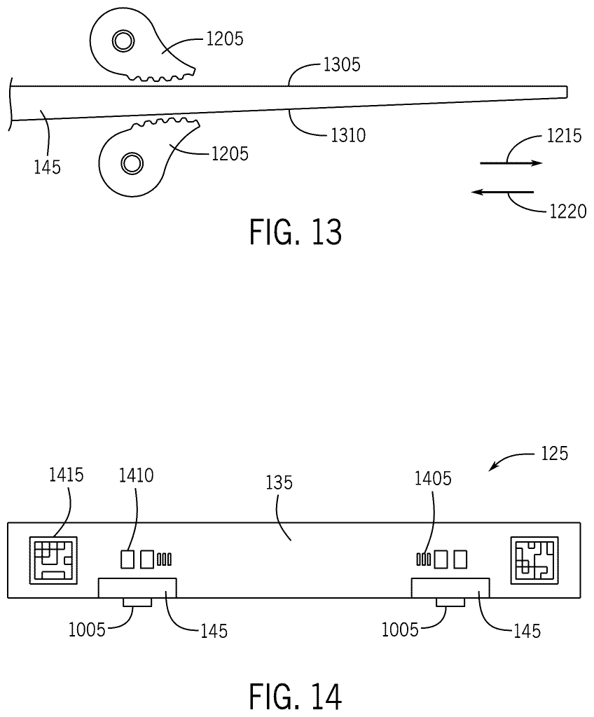

FIG. 13 shows another example of a connection mechanism 1300 for securing the automated guided vehicle 210 to the material handling vehicle 100. However, in the example shown in FIG. 13, the locking pawls 1205 may engage a surface of the forks. For example, the locking pawls 1205 may engage an upper surface 1305, a lower surface 1310, or both the upper and lower surfaces 1305, 1310 of the forks 145 instead of the sides 1210 of the forks 145. Similarly, if only a single pawl 1205 is used, the fork may be constrained between a surface (e.g., a bottom surface) of the chassis 215 and the pawl 1205. In some examples, to release the forks 145 from the locking pawls 1205 (e.g., to remove the automated guided vehicle 210 from engagement with the material handling vehicle 100) an operator may actuate a switch or button, which may release the locking pawls 1205 and permit movement of the forks 145 through the opening 1230 of the locking pawls 1205 in the direction shown by arrow 1220.

Looking now at FIG. 14, an example of the platform 125 of the material handling vehicle 100 is shown. In some examples, the platform 125 may include a communication port 1405, a charging port 1410, and one or more fiducial markers (e.g., april tags 1415, barcodes, quick-response (QR) codes, ArUco markers, WhyCon markers, WhyCode markers, etc.), arranged at an intersection between the load deck and the operator platform to facilitate connection between the automated guided vehicle 210 and the material handling vehicle 100. For example, the communication port 1405 may be used to facilitate communication between the automated guided vehicle 210 and the material handling vehicle 100 (e.g., between one or more sensors or cameras of the automated guided vehicle 210 and the material handling vehicle 100, the guidance, navigation, and control system of the automated guided vehicle 210 and the material handling vehicle 100, etc.). In another example, when the automated guided vehicle 210 docks to the material handling vehicle 100, the automated guided vehicle 210 may exchange the last known position of the automated guided vehicle 210, which may facilitate tracking of the automated guided vehicle 210 or the material handling vehicle 100. In another example, the charging port 1410 may facilitate charging of the automated guided vehicle 210 when docked or connected to the material handling vehicle 100. To facilitate accurate docking of the automated guided vehicle 210 to the material handling vehicle 100, the automated guided vehicle 210 may utilize the one or more fiducial markers (e.g., april tags 1415, barcodes, quick-response (QR) codes, ArUco markers, WhyCon markers, WhyCode markers, etc.) arranged on the platform 125 to guide the automated guided vehicle 210 onto the load deck 205 or the forks 145 (e.g., to interface a connection mechanism).

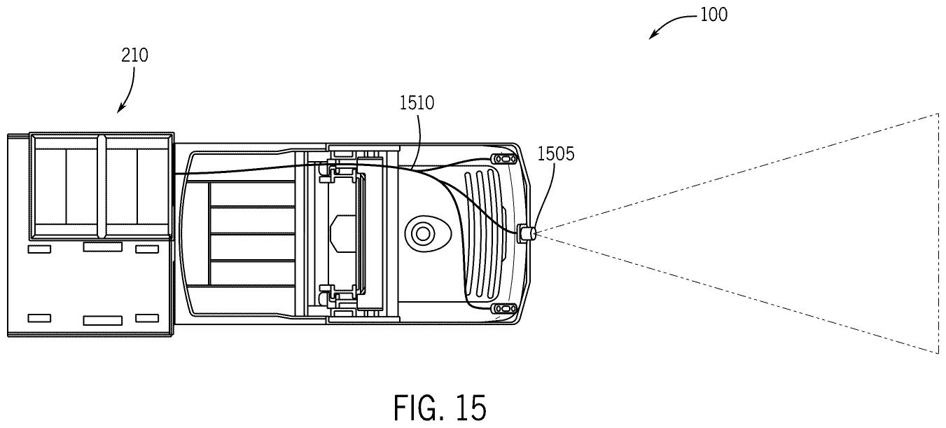

As shown in FIG. 15, the automated guided vehicle 210 may communicate with one or more sensors or cameras 1505 of the material handling vehicle 100 via a communication link 1510. In some examples, the communication link 1510 may be a wired communication link. In another example, the communication link 1510 may be a wireless communication link. For example, when the automated guided vehicle 210 docks to the material handling vehicle 100, the automated guided vehicle 210 may communicate with the sensors or cameras 1505 of the material handling vehicle 100 via the communication port 1405. In another example, the automated guided vehicle 210 may utilize the one or more sensors or cameras 1505 of the material handling vehicle 100 in combination with the internal guidance, navigation, and control system of the automated guided vehicle 210 to control movement or operation of the material handling vehicle 100. Put differently, a connection between the material handling vehicle 100 and the automated guided vehicle 210 may transition the material handling vehicle 100 from operator controlled to autonomous or controlled by the automated guided vehicle 210. Thus, the material handling vehicle 100 may benefit from the route planning systems of the automated guided vehicle 210. Similarly, in some examples, when the automated guided vehicle docks to the material handling vehicle, the material handling vehicle may communicate with one or more sensors or cameras of the automated guided vehicle via the communication link (e.g., the communication port).

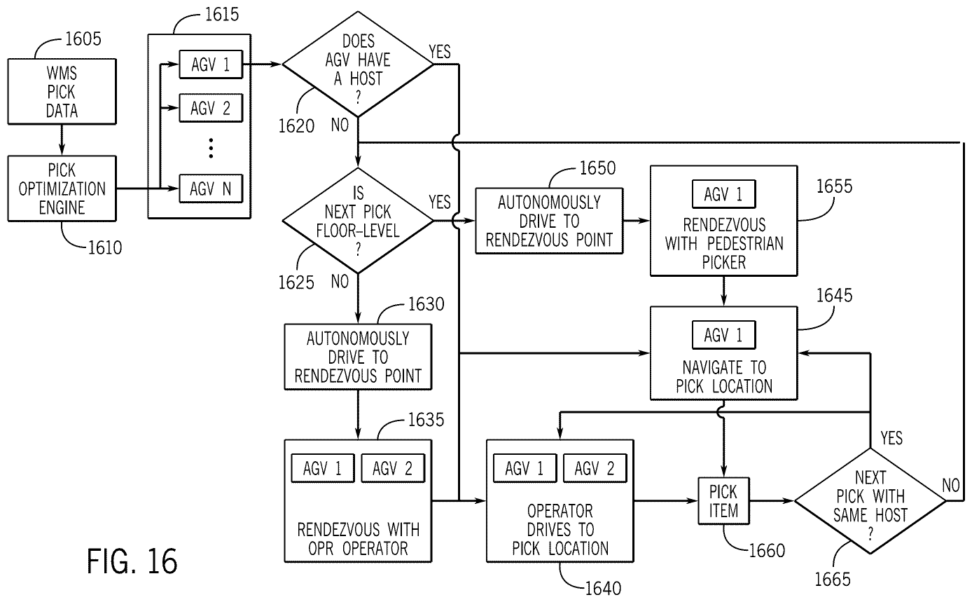

FIG. 16 shows an example of a pick process utilizing the automated guided vehicle 210 and the material handling vehicle 100. At stage 1605, a warehouse management system may receive a pick request corresponding to an item within the warehouse. At stage 1610, the pick request may pass through a pick optimization engine, which may organize pick requests based on item type, item location (e.g., zone), or other features. At stage 1615, the optimized pick requests may be transferred or uploaded to one or more automated guided vehicles 210.

Upon receiving the pick request, the automated guided vehicle 210 may determine whether or not the automated guided vehicle 210 is currently connected to a material handling vehicle 100 at stage 1620. If the automated guided vehicle 210 is connected to the material handling vehicle 100, the operator may guide the material handling vehicle 100 (including the automated guided vehicle 210) to the pick location at stage 1640. In another example, the automated guided vehicle 210 may interface with the material handling vehicle 100 (e.g., via the sensors or cameras 1505 as discussed previously) to guide the material handling vehicle 100 to the pick location autonomously at stage 1645. In either case, once arriving at the pick location, the operator may complete the pick process at stage 1660. However, if at stage 1620, the automated guided vehicle 210 is not connected to the material handling vehicle 100, then the automated guided vehicle 210 may determine whether or not the requested pick is floor-level or above floor-level at stage 1625.

If the requested pick is at the floor-level (e.g., as determined by the automated guided vehicle 210, warehouse management system, etc.), the automated guided vehicle 210 may autonomously drive to a predetermined rendezvous point at stage 1650. At stage 1655, an operator (e.g., a picker without a material handling vehicle 100) may rendezvous with the automated guided vehicle 210 at the rendezvous point. Once the picker and the automated guided vehicle 210 have rendezvoused, the automated guided vehicle 210 may guide the picker to the pick location at stage 1645. Following this, the picker may complete the pick process at stage 1660.

Correspondingly, if the requested pick is above the floor-level at stage 1625 (e.g., as determined by the automated guided vehicle 210, warehouse management system, etc.), the automated guided vehicle 210 may autonomously drive to the rendezvous point at stage 1630 for rendezvous with an operator and the material handling vehicle 100 at stage 1635. In some examples, when the operator rendezvous with the automated guided vehicle 210, the automated guided vehicle may dock to the material handling vehicle 100. Following this, the operator may drive the material handling vehicle 100 including the automated guided vehicle 210 to the pick location indicated by the automated guided vehicle 210 at stage 1640. Once at the pick location, the operator may utilize the material handling vehicle 100 and the automated guided vehicle 210 to complete the pick at stage 1660.

After completion of the pick, it may be determined (e.g., via the automated guided vehicle 210, warehouse management system, etc.) whether or not the next pick location is most efficiently executed with the same material handling vehicle 100 (e.g., based on predetermined zone boundaries, etc.). If the pick is with the same vehicle (e.g., host), the automated guided vehicle 210 may assist the operator in guiding the material handling vehicle 100 and the automated guided vehicle 210 to the next pick location. Correspondingly, if the next pick is not with the same material handling vehicle 100 at stage 1665 (as determined by the automated guided vehicle, warehouse management system, etc.), the automated guided vehicle 210 reverts to stage 1625 as described previously.

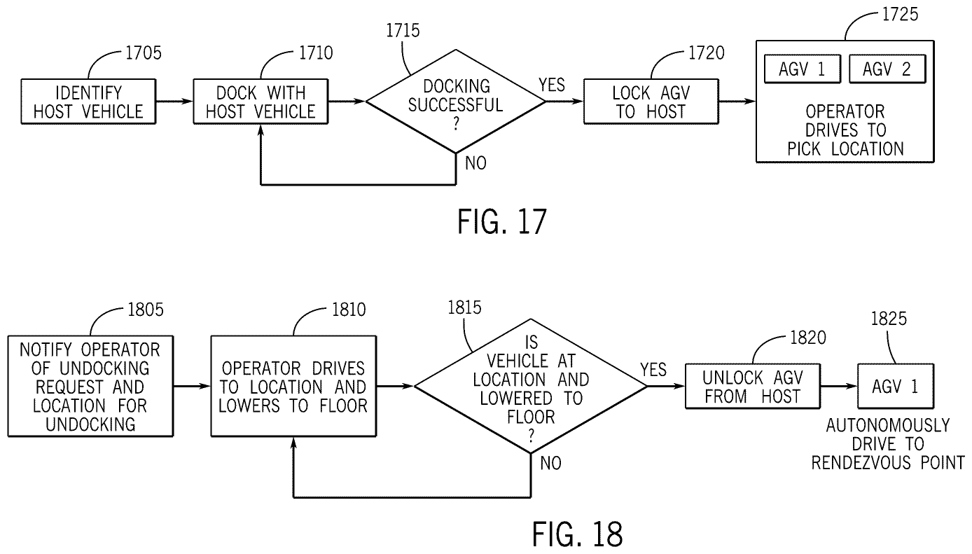

FIG. 17 shows an example of a docking process between the automated guided vehicle 210 and the material handling vehicle 100. At stage 1705, the automated guided vehicle 210 may identify the material handling vehicle 100. For example, the automated guided vehicle 210 may identify the material handling vehicle 100 via the one or more fiducial markers (e.g., april tags 1415, barcodes, quick-response (QR) codes, ArUco markers, WhyCon markers, WhyCode markers, etc.) arranged on the platform 125 of the material handling vehicle 100. At stage 1710, the automated guided vehicle 210 may begin to dock with the material handling vehicle 100. For example, the automated guided vehicle 210 may drive up the load deck 205 of the material handling vehicle 100. In another example, the automated guided vehicle 210 may engage the forks 145 of the material handling vehicle 100 as described previously. At stage 1715, the automated guided vehicle 210 (or material handling vehicle) may determine whether or not the automated guided vehicle 210 is fully docked to the material handling vehicle 100 (e.g., of the automated guided vehicle 210 has contacted the communication port 1405). If the automated guided vehicle 210 is determined to be fully docked to the material handling vehicle 100, the material handling vehicle 100 may lock the automated guided vehicle 210 into position via the connection mechanism. At stage 1725 the operator may drive the automated guided vehicle 210 and the material handling vehicle 100 to the pick location.

FIG. 18 shows an example of an undocking process between the automated guided vehicle 210 and the material handling vehicle 100. At stage 1805, the automated guided vehicle 210 may notify the operator of an undocking request. For example, the automated guided vehicle 210 may notify the operator via a display on the console 140. Further, the automated guided vehicle 210 may notify the operator of the location to undock the automated guided vehicle 210. At stage 1810 the operator may drive the material handling vehicle 100 including the automated guided vehicle 210 to the indicated undocking location and lower the automated guided vehicle 210 (e.g., via lowering the mast 120) to the floor. At stage 1815, the automated guided vehicle 210 may determine whether the automated guided vehicle 210 is positioned at the desired drop-off location and is positioned at floor-level. If the automated guided vehicle 210 is lowered and at the desired drop-off position, the material handling vehicle 100 may unlock the automated guided vehicle 210 from the material handling vehicle 100. For example, the material handling vehicle 100 may release the connection mechanism or lower the second segment 515 as described previously. At stage 1825, the automated guided vehicle 210 may depart from the material handling vehicle 100 and autonomously drive to a predetermined rendezvous point.

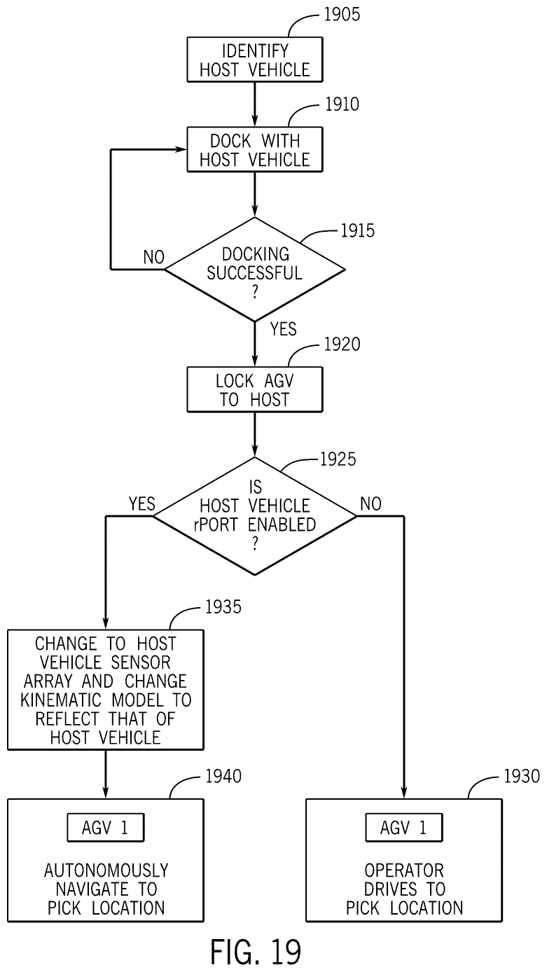

FIG. 19 shows an alternative docking process between the automated guided vehicle 210 and the material handling vehicle 100. At stage 1905, the automated guided vehicle 210 may identify the material handling vehicle 100. For example, the automated guided vehicle 210 may identify the material handling vehicle 100 via the one or more fiducial markers (e.g., april tags 1415, barcodes, quick-response (QR) codes, ArUco markers, WhyCon markers, WhyCode markers, etc.) arranged on the platform 125 of the material handling vehicle 100 (e.g., via one or more cameras or other sensors on the automated guided vehicle). At stage 1910, the automated guided vehicle 210 may begin to dock with the material handling vehicle 100. For example, the automated guided vehicle 210 may begin to advance onto the load deck (e.g., the forks 145) of the material handling vehicle 100. At stage 1915, the automated guided vehicle 210 may determine whether or not the automated guided vehicle 210 is fully docked to the material handling vehicle 100. For example, the automated guided vehicle 210 may be fully docked when contacting operator platform 135. If the automated guided vehicle 210 is determined to be fully docked to the material handling vehicle 100, the material handling vehicle 100 may lock the automated guided vehicle 210 into position via the connection mechanisms described previously.

In some examples, once the automated guided vehicle 210 is docked to the material handling vehicle 100, the automated guided vehicle 210 may determine whether or not the material handling vehicle 100 includes a communication port 1405 at stage 1925. In some examples, if the vehicle does not include a communications port 1405, the operator may guide the material handling vehicle 100 and the automated guided vehicle 210 to the pick location at stage 1930. However, if the vehicle does include a communication port, the automated guided vehicle 210 may engage with (e.g., access data from) the one or more sensors or cameras arranged throughout the material handling vehicle 100 and modify a kinematic model of the automated guided vehicle 210 to match the model of the material handling vehicle 100 at stage 1935. Following this, the automated guided vehicle 210 may guide the material handling vehicle 100 via autonomous operation at stage 1940. In another example, if the vehicle does include a communication port, the engagement between the automated guided vehicle 210 and the material handling vehicle 100 may permit the material handling vehicle to engage with (e.g., access data from) one or more sensors or cameras arranged throughout the automated guided vehicle 210.

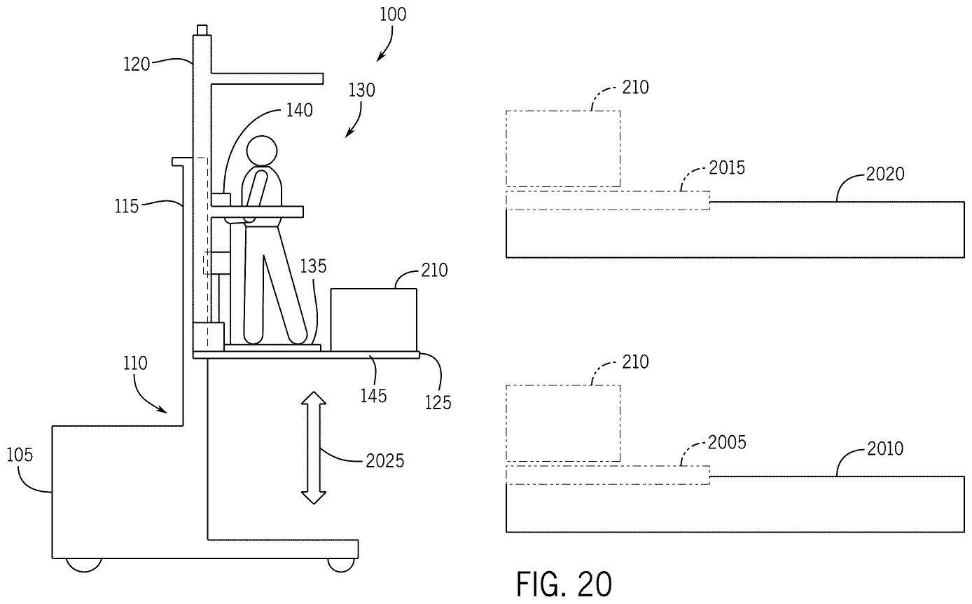

FIG. 20 shows an example of a multi-level (e.g., multi-floor) docking/undocking process using the material handling vehicle 100 to dock or undock the automated guided vehicle 210 using the platform 125. In one example, the material handling vehicle 100 may dock with the automated guided vehicle 210 at a first rendezvous location 2005 (e.g., located on a first floor 2010, first level of racking, etc.) of a warehouse or facility. For example, the automated guided vehicle 210 may drive to the rendezvous location 2005 to meet-up with an operator and the material handling vehicle 100.

In one example, the automated guided vehicle 210 may dock to the material handling vehicle 100 at the rendezvous location 2005 via the platform 125 as discussed previously. Once the automated guided vehicle 210 is docked to the material handling vehicle 100, the material handling vehicle may move (e.g., raise or lower) the automated guided vehicle 210 via the platform 125 as shown by arrow 2025. For example, the material handling vehicle 100 may raise the automated guided vehicle 210 to a second floor 2020 (e.g., second level of racking, a mezzanine, etc.) of the warehouse or facility. Once at the second floor 2020, the automated guided vehicle 210 may undock from the platform 125 of the material handling vehicle 100 at a second rendezvous location 2015.

As should be appreciated, in some examples, the material handling vehicle 100 may thus be used to transport the automated guided vehicles 210 between floors of a warehouse or facility. For example, the material handling vehicle 100 may dock with automated guided vehicles 210 at a rendezvous location on a first floor and undock with the automated guided vehicles 210 at a second rendezvous location on a second, different floor.

In some implementations, devices or systems disclosed herein can be utilized, manufactured, or installed using methods embodying aspects of the invention. Correspondingly, any description herein of particular features, capabilities, or intended purposes of a device or system is generally intended to include disclosure of a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

As used herein, unless otherwise defined or limited, directional terms are used for convenience of reference for discussion of particular figures or examples. For example, references to downward (or other) directions or top (or other) positions may be used to discuss aspects of a particular example or figure, but do not necessarily require similar orientation or geometry in all installations or configurations.

Also as used herein, unless otherwise limited or defined, “integral” and derivatives thereof (e.g., “integrally”) describe elements that are manufactured as a single piece without fasteners, adhesive, or the like to secure separate components together. For example, an element stamped, cast, or otherwise molded as a single-piece component from a single piece of sheet metal or using a single mold, without rivets, screws, or adhesive to hold separately formed pieces together is an integral (and integrally formed) element. In contrast, an element formed from multiple pieces that are separately formed initially then later connected together, is not an integral (or integrally formed) element.

Additionally, unless otherwise specified or limited, the terms “about” and “approximately,” as used herein with respect to a reference value, refer to variations from the reference value of ±15% or less, inclusive of the endpoints of the range. Similarly, the term “substantially equal” (and the like) as used herein with respect to a reference value refers to variations from the reference value of less than ±30%, inclusive. Where specified, “substantially” can indicate in particular a variation in one numerical direction relative to a reference value. For example, “substantially less” than a reference value (and the like) indicates a value that is reduced from the reference value by 30% or more, and “substantially more” than a reference value (and the like) indicates a value that is increased from the reference value by 30% or more.

The previous description of the disclosed embodiments is provided to enable any person skilled in the art to make or use the invention. Given the benefit of this disclosure, various modifications to these embodiments will be readily apparent to those skilled in the art, and the principles defined herein may be applied to other embodiments without departing from the spirit or scope of the invention. Thus, the invention is not intended to be limited to the embodiments shown herein but is to be accorded the widest scope consistent with the principles and novel features disclosed herein.

### FURTHER EXAMPLES

Example 1. A material handling vehicle, the material handling vehicle comprising: a vertically moveable platform including an operator compartment, a load deck, and one or more forks extending outward from the vertically moveable platform; and a connection mechanism secured to an underside of the one or more forks, the connection mechanism to secure an automated guided vehicle to the load deck so that vertical movement of the load deck elicits corresponding vertical movement of the automated guided vehicle.

Example 2. The material handling vehicle of Example 1, wherein the connection mechanism is pivotally mounted to the underside of the one or more forks via a mounting shaft.

Example 3. The material handling vehicle of Example 2, wherein the connection mechanism includes an angled surface to guide a crossmember of the automated guided vehicle into a cutout of the connection mechanism to retain the automated guided vehicle to the material handling vehicle.

Example 4. The material handling vehicle of any previous Example, wherein the connection mechanism includes a locking pawl mounted to an underside of the automated guided vehicle.

Example 5. The material handling vehicle of Example 4, wherein the locking pawl engages a surface of the fork to secure the automated guided vehicle to the material handling vehicle.

Example 6. The material handling vehicle of any previous Example, wherein the load deck includes a series of slots to retain one or more wheels of the automated guided vehicle.

Example 7. The material handling vehicle of any previous Example, wherein the load deck includes a first segment and a second segment, and wherein the second segment of the load deck rotates from a position parallel to the first segment to a position perpendicular to the second segment to retain the automated guided vehicle on the load deck.

Example 8. The material handling vehicle of any previous Example, wherein the vertically moveable platform includes a communication port to facilitate communication between the automated guided vehicle and the material handling vehicle.

Example 9. The material handling vehicle of Example 8, wherein connecting the automated guided vehicle and the material handling vehicle via the communication port permits the automated guided vehicle to utilize one or more sensors of the material handling vehicle.

Example 10. The material handling vehicle of any previous Example, wherein the vertically moveable platform includes a charging port.

Example 11. The material handling vehicle of any previous Example, wherein the vertically moveable platform includes a fiducial marker to guide engagement between the automated guided vehicle and the material handling vehicle.

Example 12. The material handling vehicle of Example 11, wherein the fiducial marker is one of: an april tag, a barcode, a quick-response (QR) code, an ArUco marker, a WhyCon marker, or a WhyCode marker.

Example 13. A method of docking an automated guided vehicle to a material handling vehicle, the method comprising: identifying a material handling vehicle via fiducial marker arranged on the material handling vehicle; beginning to dock the automated guided vehicle to the material handling vehicle by guiding the automated guided vehicle onto a load deck of the material handling vehicle; and securing the automated guided vehicle to the load deck of the material handling vehicle via a connection mechanism secured to the load deck.

Example 14. The method of Example 13, wherein, when the automated guided vehicle is secured to the material handling vehicle, vertical movement of the load deck elicits corresponding vertical movement of the automated guided vehicle.

Example 15. The method of Example 14, wherein vertical movement of the load deck transports the automated guided vehicle between a first floor and a second, different floor of a facility.

Example 16. The method of Example 15, further comprising: docking the automated guided vehicle to the material handling vehicle at a first rendezvous location on the first floor; and undocking the automated guided vehicle from the material handling vehicle at a second rendezvous location on the second floor.

Example 17. The method of Examples 13 to 16, further comprising: guiding a crossmember of the automated guided vehicle into a cutout of the connection mechanism, via an angled surface on one end of the connection mechanism, to secure the automated guided vehicle to the material handling vehicle.

Example 18. The method of Examples 13 to 17, further comprising: engaging a fork of the material handling vehicle with a locking pawl mounted to an underside of the automated guided vehicle so that the locking pawl contacts a surface of the fork to secure the automated guided vehicle to the material handling vehicle.

Example 19. The method of Examples 13 to 18, further comprising: when the automated guided vehicle is secured to the load deck of the material handling vehicle, connecting the automated guided vehicle to a communication port arranged on the load deck to permit the automated guided vehicle to utilize one or more sensors of the material handling vehicle.

Example 20. The method of Example 19, further comprising: when the automated guided vehicle is connected to the communication port, taking control, via the automated guided vehicle, of one or more sensors of the material handling vehicle to permit the automated guided vehicle to guide movement of the material handling vehicle.

1. A material handling vehicle, the material handling vehicle comprising:
a vertically moveable platform including an operator compartment, a load deck, and one or more forks extending outward from the vertically moveable platform; and
a connection mechanism secured to an underside of the one or more forks, the connection mechanism to secure an automated guided vehicle to the load deck so that vertical movement of the load deck elicits corresponding vertical movement of the automated guided vehicle.

2. The material handling vehicle of claim 1, wherein the connection mechanism is pivotally mounted to the underside of the one or more forks via a mounting shaft.

3. The material handling vehicle of claim 1, wherein the connection mechanism includes an angled surface to guide a crossmember of the automated guided vehicle into a cutout of the connection mechanism to retain the automated guided vehicle to the material handling vehicle.

4. The material handling vehicle of claim 1, wherein the connection mechanism includes a locking pawl mounted to an underside of the automated guided vehicle.

5. The material handling vehicle of claim 4, wherein the locking pawl engages a surface of the fork to secure the automated guided vehicle to the material handling vehicle.

6. The material handling vehicle of claim 1, wherein the load deck includes a series of slots to retain one or more wheels of the automated guided vehicle.

7. The material handling vehicle of claim 1, wherein the load deck includes a first segment and a second segment, and wherein the second segment of the load deck rotates from a position parallel to the first segment to a position perpendicular to the second segment to retain the automated guided vehicle on the load deck.

8. The material handling vehicle of claim 1, wherein the vertically moveable platform includes a communication port to facilitate communication between the automated guided vehicle and the material handling vehicle.

9. The material handling vehicle of claim 8, wherein connecting the automated guided vehicle and the material handling vehicle via the communication port permits the automated guided vehicle to utilize one or more sensors of the material handling vehicle.

10. The material handling vehicle of claim 1, wherein the vertically moveable platform includes a charging port.

11. The material handling vehicle of claim 1, wherein the vertically moveable platform includes a fiducial marker to guide engagement between the automated guided vehicle and the material handling vehicle.

12. The material handling vehicle of claim 11, wherein the fiducial marker is one of:
an april tag;
a barcode;
a quick-response (QR) code;
an ArUco marker;
a WhyCon marker; or
a WhyCode marker.

13. A method of docking an automated guided vehicle to a material handling vehicle, the method comprising:
identifying a material handling vehicle via fiducial marker arranged on the material handling vehicle;
beginning to dock the automated guided vehicle to the material handling vehicle by guiding the automated guided vehicle onto a load deck of the material handling vehicle; and
securing the automated guided vehicle to the load deck of the material handling vehicle via a connection mechanism secured to the load deck.

14. The method of claim 13, wherein, when the automated guided vehicle is secured to the material handling vehicle, vertical movement of the load deck elicits corresponding vertical movement of the automated guided vehicle.

15. The method of claim 14, wherein vertical movement of the load deck transports the automated guided vehicle between a first floor and a second, different floor of a facility.

16. The method of claim 15, further comprising:
docking the automated guided vehicle to the material handling vehicle at a first rendezvous location on the first floor; and
undocking the automated guided vehicle from the material handling vehicle at a second rendezvous location on the second floor.

17. The method of claim 13, further comprising:
guiding a crossmember of the automated guided vehicle into a cutout of the connection mechanism, via an angled surface on one end of the connection mechanism, to secure the automated guided vehicle to the material handling vehicle.

18. The method of claim 13, further comprising:
engaging a fork of the material handling vehicle with a locking pawl mounted to an underside of the automated guided vehicle so that the locking pawl contacts a surface of the fork to secure the automated guided vehicle to the material handling vehicle.

19. The method of claim 13, further comprising:
when the automated guided vehicle is secured to the load deck of the material handling vehicle, connecting the automated guided vehicle to a communication port arranged on the load deck to permit the automated guided vehicle to utilize one or more sensors of the material handling vehicle.

20. The method of claim 19, further comprising:
when the automated guided vehicle is connected to the communication port, taking control, via the automated guided vehicle, of one or more sensors of the material handling vehicle to permit the automated guided vehicle to guide movement of the material handling vehicle.
